(19) United States
(12) Patent Application Publication
(10) Pub. No.: US 2007/0164807 A1
(43) Pub. Date: Jul. 19, 2007

(54) Fuse repair circuit and its operating method

(75) Inventors: Xiao Long Wu, Tam-Shui (TW); Yi Chou Huang, Tam-Shui (TW)

Correspondence Address: HDSL, 4331 STEVENS BATTLE LANE, FAIRFAX, VA, 22033, US

(73) Assignee: Fortune Semiconductor Corporation

(21) Appl. No.: 11/331,108

(22) Filed: Jan. 13, 2006

(51) Int. Cl. H01H 37/76

(52) U.S. Cl. 327/525

(57) ABSTRACT

A fuse repair circuit and an operating method thereof provide a voltage source and a control signal to a switch, and an end of the switch is connected to a first end of a fuse, and a second end of the fuse is connected to a ground voltage, and the control signal controls whether or not to electrically connect the switch to blow the fuse, and signals outputted from the first and second ends of the fuse are detected to confirm whether or not the fuse is blown.

### BACKGROUND OF THE INVENTION

1. Field of the Invention

The present invention relates to a fuse repair circuit, and more particularly to a repair fuse circuit and its operating method that adopt a metal oxide semiconductor transistor.

2. Description of Prior Art

At present, fuse bit is used extensively in many areas, such as an application that requires a permanent programmed numeric value having one or more bits. In the application of a temperature sensor, the change of a temperature parameter of a metal oxide semiconductor (MOS) varies according to different manufacturing processes. If a chip is produced and the ungraded temperature sensor chip is not corrected, the measured value will have no significance. Therefore, it is necessary to use an additional parameter to program the chip for its normal operation.

Referring to FIG. 1 for the fuse repair circuit as disclosed in U.S. Pat. No. 6,654,304, a VDD voltage source is connected to a fuse F1 and also connected to a metal oxide semiconductor transistor MNO and then connected to a ground voltage. After the control signal TRIM passes through the inverters U1, U2, the control signal TRIM is inputted to the transistor MNO. If the transistor MNO is electrically connected, the transistor MNO will pass sufficient current to blow the fuse F1, so as to form an open circuit. The current source circuit 12 is electrically connected to a node 10, and a source and a drain of a transistor MN1 are connected to a node 10, and another source and another drain are connected to a ground voltage. A bias voltage VB inputted to a gate of the transistor MN1 provides a small current (2˜5 μA), and the inverter U3 changes the voltage potential transmitted from the node 10 and then outputs the voltage potential.

If the voltage source VDD supplies a current and the fuse F1 is not blown, there will be a small voltage drop at both ends of the fuse F1, such that the voltage at the node 10 will nearly equal to the voltage source VDD, and the output of the inverter U3 will be logical low. If the transistor MNO is electrically connected, the fuse F 1 will be blown, and the current I1 will make the voltage at the node 10 close to the ground voltage, and the output of the inverter U3 will become logical high. Therefore, the output status of the inverter U3 is programmable. If the fuse F1 is not blown, then a tiny current will pass through the fuse F1 and the transistor MN1. The fuse repair cells of this sort usually consume a considerable amount of electric power.

In summation of the description above, the prior art fuse repair circuit inputs a control signal TRIM to a gate of the transistor MNO. Due to a possible manufacturing error of the transistor, the voltage supplied to the transistor may be deviated, and thus affecting the current passing through the fuse F1. As a result, the fuse F1 may be blown or other components may be damaged.

### SUMMARY OF THE INVENTION

The present invention is to overcome the shortcomings of the prior art and avoid the existing deficiencies by providing a fuse repair circuit that comprises a voltage source, a switch, and a fuse, and a first end of the fuse is connected to a voltage source through the switch, and a second end of the fuse is connected to a ground voltage, wherein a control signal controls the switch whether or not to blow the fuse, and the signals outputted from the first and second ends of the fuse are detected to confirm whether or not the fuse is blown.

Another, the present invention is to provide a method for controlling the blowing of a fuse, wherein a voltage source is provided and connected to a first end of the fuse through a switch, and a second end of the fuse is connected to a ground voltage. If the switch is electrically connected, the voltage source will provide a current passing through the fuse from the switch to blow the fuse.

Further, the present invention is to provide a method of detecting whether or not a fuse is blown, wherein a voltage source is provided and connected to a first end of the fuse through a switch, and a second end of the fuse is connected to a ground voltage, and a potential difference detected from the first and second ends of the fuse is used for determining whether or not the fuse is blown.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a fuse repair circuit of a prior art; and

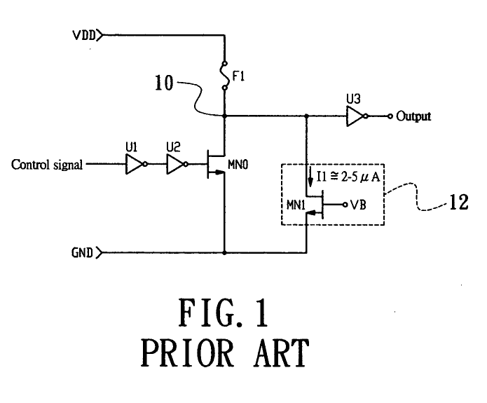

FIG. 2 shows a fuse repair circuit of the present invention.

### DETAILED DESCRIPTION OF THE INVENTION

The technical characteristics, features and advantages of the present invention will become apparent in the following detailed description of the preferred embodiments with reference to the accompanying drawings.

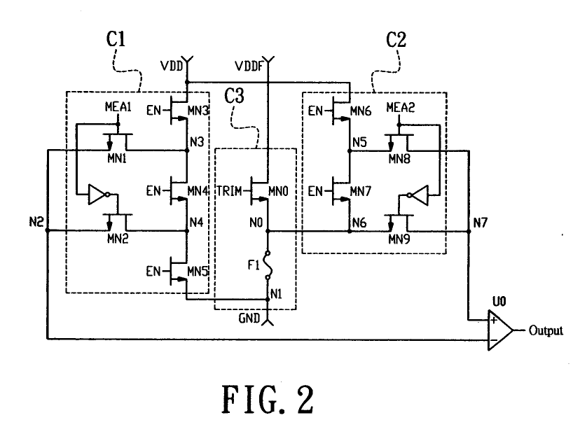

Referring to FIG. 2 for the fuse bit control circuit of the present invention, a fuse bit according to a preferred embodiment of the invention is considered as a write-once programmable memory bit for storing a numeric value (such as “High” or “Low”). The control circuit of such fuse repair cell is supplied with two power sources, one acting as a voltage source VDD of a system voltage and the other being used as a voltage source VDDF of a blown fuse, wherein GND stands for the ground voltage of the system, and C3 stands for the fuse repair circuit. In the fuse repair circuit C3, the voltage source VDDF is connected to an end NO of a fuse F1 through a metal oxide semiconductor (MOS) transistor MN0, an end N1 of the fuse F1 is connected to a ground voltage. A gate of the transistor MN0 is controlled by a control signal TRIM, and the transistor MN0 of this preferred embodiment is an N-channel metal oxide transistor (NMOS transistor) or a P-channel metal oxide transistor (PMOS transistor). The control signal TRIM controls whether or not to turn on a channel of the transistor MN0, and a drain and a source of the transistor MN0 are connected to the voltage source VDDF and the fuse F1 respectively, such that if the channel of the transistor MN0 is electrically connected, the current from the voltage source VDDF will pass through the transistor MN0 to the fuse F1 and then to the ground voltage. Therefore, the transistor MN0 is electrically connected to pass a current to the fuse F1 for blowing the fuse F1.

Referring to FIG. 2, the voltage difference between the ends N0, N1 is very small (because the fuse F1 has a very small voltage drop), if the fuse F1 is not blown. If the fuse F1 is blown, the potential at the end N0 is the voltage provided by the voltage source VDDF and the potential at the end N1 is the potential of the ground end, and thus the potential difference between the ends N0, N1 is very large. By comparing the potential difference between the ends N0, N1, we can know whether or not the fuse F 1 is blown as well as the data status of this fuse bit.

Further, a first check circuit C1 and a second check circuit C2 are used for checking the status (such as blown or electrically connected) of the fuse F1. The two voltages at nodes N2, N7 are the inputs of a comparator U0. After the comparator U0 compares the voltage, a numeric value of “High” or “Low” is outputted. The outputs of the comparator U0 can tell us whether or not the fuse is blown.

At the beginning, an enable signal EN, a first measured signal MEA1, a second measured signal MEA2, and a control signal, TRIM are logical low, and thus the output of the comparator U0 is also logical low. The control signal TRIM is a signal for controlling the blowing of the fuse F1, and if the control signal TRIM is set to logical high, then a large current will flow from the voltage source VDDF towards the ground voltage GND and then will pass through the fuse F1. The input signals EN, MEA1 and MEA2 are enable signals of the circuits C1, C2, so that the circuits C1, C2 can check the fuse repair status. If the fuse is blown, then the output of the comparator U0 will be changed from logical low to logical high. In FIG. 2, the transistor MN0 will be turned off and the current supplied by the voltage source VDDF will be stopped, if the fuse F1 is blown. The potential difference between the ends N0, N1 of the fuse F1 is checked by the first check circuit C1 and the second check circuit C2 to confirm that the fuse F1 is blown. The output of the comparator U0 is changed from logical low to logical high, and the control signal TRIM is changed from logical high to logical low to turn off the transistor MN0 and stop supplying current to the voltage source VDDF, so as to complete the process of blowing the fuse F1.

In FIG. 2, the input signals EN, EN, MEA1 are set to logical high and the input signal MEA2 is set to logical low at the beginning of the fuse repairing procedure to prepare for checking the status of the fuse F1. If a fuse is selected for writing data, then the control signal TRIM will be set to logical high. The N-channel metal oxide semiconductor transistor MN0 is electrically connected to pass sufficient current to blow the fuse F1. Then, the nodes N0, N1 are in an open circuit state, and a voltage change occurs between the two nodes N0, N1. The voltage change between the nodes N0, N1 is measured under the conditions of setting the input signals EN, MEA1 to logical high and MEA2 to logical low for the circuits C1, C2. Since the fuse F1 is at an open circuit state, the voltages at the nodes N5, N6 will be pulled close to logical high, and the voltages at the nodes N3, N4 will be pulled close to logical low. The measured voltages of the circuits C1, C2 are reflected to the nodes N2, N7 respectively and act as an analog input of the comparator U0, wherein the voltage at the node N2 approaches logical low, and the voltage at the node N7 is pulled close to logical high. If any of the two inputs of the comparator U0 is logical high and the other input is logical low, then the output OUT of the comparator U0 will be changed from logical low to logical high. Such change will inform the fuse programming circuit to set the control signal TRIM to logical low and stops the fuse repair. If the output OUT is logical high, it indicates that the fuse is blown and the fuse cell stores a numeric value of “high”.

In other words, if the fuse repair circuit C3 is not selected for writing data, then the control signal TRIM will be set to logical low, and the switch MN0 will stop the current flowing between VDDF and GND, and the fuse F1 is not blown. If the input signals EN, MEA1 are set to logical high and the input signal MEA2 to logical low, the circuits C1, C2 will measure the voltage between the nodes N0, N1. Since the fuse F1 is not blown, therefore the voltages at nodes N5, N6 are pulled close to logical low, and then the node N3, N4 are logical low. Since the two inputs of the comparator U0 are both logical low, the output OUT of the comparator U0 will output a logical low, indicating that the fuse cell stores a numeric value of “low”.

To end the fuse programming procedure, the input signals EN, MEA1, MEA2 and the control signal TRIM are set to logical low, and thus the VDDF is floating. Such setup can prevent possible power loss between the circuit C1 and the ground GND or between the circuit C2 and the ground GND.

If the control signal TRIM received by the fuse repair circuit C3 is set to 5 volts (so that the switch MN0 is electrically connected), the power supplied by the voltage source VDDF for the fuse repair will pass through the switch MN0 (which is an NMOS transistor). On the other hand, if the control signal TRIM is set to 0 volt (so that the switch MN0 is turned off), the voltage source VDDF for the fuse repair will be disconnected. Since the switch MN0 is an NMOS transistor, therefore the voltage source VDDF for the fuse repair supplied to the switch MN0 will not have a voltage limitation.

If the switch MN0 is a PMOS transistor, the voltage supplied by the voltage source VDDF for the fuse repair will be less than 5.8 volts (assumed that the absolute critical voltage of the PMOS transistor is 0.8 volt). If the voltage supplied by the voltage source VDDF for the fuse repair is greater than or equal to 5.8 volts, the switch MN0 will be connected electrically and damaged, regardless of the voltage of the control signal TRIM being 0 volt or 5 volts.

Since the voltage VDDF is used during the repair only, therefore the voltage VDDF will be in a floating state after the repair, and the control signal TRIM will be set to logical low permanently. When data is read, the input signals EN, MEA2 are set to logical high and the input signal MEA1 is set to logical low. If the fuse repair cell is programmed (in other words, the fuse F1 is blown), then the node N1 will form an open circuit. If the voltage at the node N0 is not logical low, then the voltage at the node N1 will be logical low. Thus, the voltage at the node N2 will be logical low and the voltage at the node N7 will be logical high. The voltages at the nodes N2, N7 will be the inputs of the comparator U0. Therefore, an open circuit is formed by the nodes N0, N1, and the output of the comparator U0 is logical high. Then, the input signals EN, MEA1, MEA2 will be set to logical low to end the reading procedure and avoid power loss.

If the input signals EN, MEA2 are set to logical high, and the input signal MEA1 is set to logical low, and the fuse cell is not programmed such that the fuse F1 is not blown, the nodes N0, N1 will be electrically connected to ground, and the nodes N2, N7 will be logical low, and the output of the comparator U0 will remain logical low. Then, the input signals EN, MEA1, MEA2 are set to logical low to end the reading procedure and avoid power loss.

In summation of the description above, the fuse repair circuit of the preferred embodiment of the present invention has the following advantages:

1. After the chip is produced, different voltages VDDF are supplied to adjust the fuse repair to an optimal result, and if the switch is an NMOS transistor, the voltage VDDF will not be restricted.

2. Since it is not necessary to adjust the parameter for the fuse and the voltage VDD, therefore we can greatly save cost and time.

3. Since it only needs to adjust the voltage VDDF without the need of adjusting the fuse, any change resulted from the manufacturing process can be eliminated

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A fuse repair circuit, comprising:
a voltage source;
a switch, electrically coupled to the voltage source, and having an end provided for inputting a control signal; and
a fuse, having a first end and a second end, and the first end of the fuse being electrically coupled to a switch, and the second end of the fuse being electrically coupled to a ground voltage;
wherein a control signal controls whether or not to electrically connect the switch to blow the fuse, and the signals outputted from the first end and the second end of the fuse are detected to confirm whether or not the fuse is blown.

2. The fuse repair circuit of claim 1, further comprising a comparator, and signals from the first end and the second end of the fuse are inputted to the comparator to confirm whether or not the fuse is blown.

3. The fuse repair circuit of claim 2, wherein the outputs of the comparator are in opposite states whenever the fuse is blown and not blown respectively.

4. The fuse repair circuit of claim 1, wherein the switch is a metal oxide semiconductor (MOS) transistor, and the control signal controls a gate of the transistor, such that if the transistor is electrically connected, the current produced by the voltage source will pass from the transistor to the ground voltage through the fuse to blow the fuse.

5. The fuse repair circuit of claim 4, wherein the source and drain of the NMOS transistor are coupled to the voltage source and the first end of the fuse respectively, such that if the gate receives the control signal to electrically connect a channel of the transistor, the voltage source will pass a current from the transistor to the fuse to blow the fuse.

6. The fuse repair circuit of claim 1, wherein the first end of the fuse maintains a high potential and the second end of the fuse maintains a low potential, if the fuse is blown, and the fuse is determined to be blown according to the existence of a potential difference between the first end and the second end of the fuse.

7. The fuse repair circuit of claim 1, wherein the first and second ends of the fuse maintain a high potential, if the switch is electrically connected and the fuse is not blown, and the fuse is determined to be not blown according to the non-existence of a potential difference between the first and second ends of the fuse.

8. A method of repairing a fuse, comprising:
providing a voltage source to a switch;
providing a control signal to the switch; and
passing a current provided by the voltage source to a ground voltage through the switch and the first and second ends of the fuse to blow the fuse, when the control signal drives the switch to be electrically connected.

9. The method of repairing a fuse of claim 8, wherein the switch is a metal oxide semiconductor (MOS) transistor, and a gate of the transistor is coupled to a control signal, such that if the transistor is electrically connected, a current provided by the voltage source will pass from the transistor through the fuse to blow the fuse.

10. The method of repairing a fuse of claim 9, wherein a source and a drain of the transistor are coupled to the voltage source and the first end of the fuse respectively, such that if the transistor is electrically connected, a current will flow from the voltage source through a channel of the transistor to the fuse to blow the fuse.

11. The method of repairing a fuse of claim 8, wherein the switch will be turned off and the current supplied by the voltage source will be stopped, if the fuse is blown.

12. The method of repairing a fuse of claim 8, wherein the potential difference between the first and second ends of the fuse is checked by a comparator to confirm if the fuse is blown, so as to send out a signal for turning off the switch and stopping supplying current to the voltage source.

13. The method of repairing a fuse of claim 8, wherein the potential difference between the first and second ends of the fuse is used for confirming whether or not the fuse is blown.

14. The method of repairing a fuse of claim 13, wherein the potential difference between the first and second ends of the fuse is compared by a comparator, and the output signals of the comparator are in opposite states when the fuse is blown and not blown respectively.

15. The method of repairing a fuse of claim 8, wherein the first end of the fuse maintains a high potential and the second end of the fuse maintains a low potential, if the fuse is blown, and the fuse is determined to be blown according to the existence of a potential difference between the first end and the second end of the fuse.

16. The method of repairing a fuse of claim 8, wherein the first and second ends of the fuse maintain a high potential, if the switch is electrically connected and the fuse is not blown, and the fuse is determined to be not blown according to the non-existence of a potential difference between the first and second ends of the fuse.

17. A method of detecting whether or not a fuse is blown, comprising:
providing a voltage source;
connecting the voltage source to a first end of the fuse through a switch;
connecting a second end of the fuse to a ground voltage; and
detecting a potential difference between the first and second ends of the fuse to determine whether or not the fuse is blown.

18. The method of detecting whether or not a fuse is blown of claim 17, wherein the switch is a metal oxide semiconductor (MOS) transistor, and a gate of the transistor is coupled to a control signal, such that if the transistor is electrically connected, the current produced by the voltage source will pass from the transistor to the ground voltage through the fuse to blow the fuse.

19. The method of detecting whether or not a fuse is blown of claim 18, wherein a source and a drain of the transistor are coupled to the voltage source and the first end of the fuse respectively, such that if the transistor is electrically connected, a current will flow from the voltage source and will pass from a channel of the transistor to the fuse to blow the fuse.

20. The method of detecting whether or not a fuse is blown of claim 17, wherein the switch will be turned off and the current supplied by the voltage source will be stopped, if the fuse is blown.

21. The method of detecting whether or not a fuse is blown of claim 20, wherein the potential difference between the first and second ends of the fuse is checked by a comparator to confirm if the fuse is blown, so as to send out a signal for turning off the switch and stopping supplying current to the voltage source.

22. The method of detecting whether or not a fuse is blown of claim 21, wherein the potential difference between the first and second ends of the fuse is checked by a comparator, and the output signals of the comparator are in opposite states when the fuse is blown and not blown respectively.

23. The method of detecting whether or not a fuse is blown of claim 17, wherein the first end of the fuse maintains a high potential and the second end of the fuse maintains a low potential, if the fuse is blown, and the fuse is determined to be blown according to the existence of a potential difference between the first end and the second end of the fuse.

24. The method of detecting whether or not a fuse is blown of claim 17, wherein the first and second ends of the fuse maintain a high potential, if the switch is electrically connected and the fuse is not blown, and the fuse is determined to be not blown according to the non-existence of a potential difference between the first and second ends of the fuse.
